(19) United States
(12) Patent Application Publication
(10) Pub. No.: US 2019/0297526 A1
(43) Pub. Date: Sep. 26, 2019

(54) MITIGATING CHANNEL CONGESTION IN INTER VEHICLE COMMUNICATION

(71) Applicant: Ford Global Technologies, LLC, Dearborn, MI (US)

(72) Inventors: Sushanta Das, Canton, MI (US); John Cardillo, Windsor (CA); Samer Ibrahim, Dearborn, MI (US); Jovan Milivoje Zagajac, Ann Arbor, MI (US)

(21) Appl. No.: 15/927,813

(22) Filed: Mar. 21, 2018

(51) Int. Cl. H04W 28/02; H04L 29/08; H04W 24/08; H04W 72/04

(52) U.S. Cl. CPC H04W 28/0289; H04L 67/12; H04W 72/0453; H04W 24/08; H04W 28/0284

(57) ABSTRACT

Method and apparatus are disclosed for mitigating channel congestion in inter-vehicle communication. An example vehicle comprising includes a wireless communication module and an intervehicle communication module. The intervehicle communication module forms a communication group with other vehicles based on vehicle characteristics. The intervehicle communication module also monitors network congestion of a first channel. Additionally, in response to detecting network congestion on the first channel, the intervehicle communication module broadcasts a switch message to instruct the other vehicles to switch to a second channel, and broadcasts safety messages on the second channel.

### TECHNICAL FIELD

The present disclosure generally relates to inter-vehicle communication and, more specifically, mitigating channel congestion in inter-vehicle communication.

### BACKGROUND

Increasingly, vehicles are manufactured to include inter-vehicle communication capabilities to facilitate data sharing between vehicles. One such example protocol is Dedicated Short Range Communication (DSRC). The DSRC protocol is being developed as a part of the Intelligent Transportation System. The DSRC protocol enables different forms of communications, such as vehicle-to-vehicle (V2V), vehicle-to-infrastructure (V2I), and vehicle-to-pedestrian (V2P) (collectively “V2X”). The aim of deploying the DSRC protocol is to reduce fatalities, injuries, property destruction, time lost in traffic, fuel consumption, exhaust gas exposure, among others.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for mitigating channel congestion in inter-vehicle communication. An example vehicle comprising includes a wireless communication module and an intervehicle communication module. The intervehicle communication module forms a communication group with other vehicles based on vehicle characteristics. The intervehicle communication module also monitors network congestion of a first channel. Additionally, in response to detecting network congestion on the first channel, the intervehicle communication module broadcasts a switch message to instruct the other vehicles to switch to a second channel, and broadcasts safety messages on the second channel.

An example method to control a vehicle includes forming a communication group with other vehicles within communication range of an intervehicle communication module based on vehicle characteristics. The method also includes monitoring network congestion of a first channel. Additionally, the method includes, in response to detecting network congestion on the first channel, broadcasting a switch message to instruct the other vehicles to switch to a second channel and broadcasting safety messages on the second channel.

An example system includes a plurality of vehicles and a roadside unit. The plurality of vehicle (i) broadcasts safety messages on a first channel, (ii) monitors network congestion of the first channel, and (iii) in response to detecting network congestion on the first channel, broadcasts a switch request message. The roadside unit (i) assigns a first set of the plurality of vehicles into a first communication group based on a first set of common vehicle characteristics and (ii) assigns a second set of the plurality of vehicles into a second communication group based on a second set of common vehicle characteristics. Additionally, the roadside unit, in response to receiving a threshold number of switch request message from different ones of the plurality of vehicles over a threshold period of time, broadcasts a directive message to the first set of the plurality of vehicles in the first communication group. The directive message causing the first set of the plurality of vehicles to change parameters of broadcasting the safety messages.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a vehicle operating in accordance with the teachings of this disclosure.

FIG. 2 illustrates the vehicles of FIG. 1 formed into communication groups.

FIG. 3 illustrates a roadside unit coordinating the communication groups.

FIG. 4A is a block diagram of electronic components of the vehicles of FIGS. 1, 2, and 3.

FIG. 4B is a block diagram of the electronic components of the roadside units of FIGS. 1, 2, and 3.

FIG. 5 is a flowchart of a method to coordinate communication groups to mitigate network congestion, which may be implemented by the electronic components of FIG. 4A.

FIGS. 6A and 6B are a flowchart of a method to coordinate communication groups to mitigate network congestion, which may be implemented by the electronic components of FIGS. 4A and 4B.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

The Federal Communication Commission has allocated 75 MHz of bandwidth between 5.850 to 5.925 GHz to be used for inter-vehicle communication (specifically, Dedicated Short Range Communication (DSRC)). This bandwidth is split into seven channels: Channel 172 (5.855 to 5.865 GHz), Channel 174 (5.865 to 5.875 GHz), Channel 176 (5.875 to 5.885 GHz), Channel 178 (5.885 to 5.895 GHz), Channel 180 (5.895 to 5.905 GHz), Channel 182 (5.905 to 5.915 GHz), and Channel 184 (5.915 to 5.925 GHz). Channel 172 (sometimes referred to herein as the “safety channel”) is dedicated to safety messages that communication vehicle characteristics (e.g., speed, direction of travel, location, etc.) to facilitate accident avoidance and mitigation, and safety of life and property applications. However, when a large number of vehicles are near each other (e.g., during traffic congestion, etc.), the safety channel can become congested. DSRC uses time-division multiple access (TDMA) channel access, which divides the channel into different time slots. For example, a 300 byte safety message may be sent 10 times per second, which is 24 kilabits per second (kbps). This 24 kbps can consume 4 milliseconds (ms) of time. As a result, the channel can become congested (e.g., there are not enough time slots for all the vehicles to transmit all of their safety messages) when 250 vehicles are within a 1000 meter communications range. The Channel Busy Ratio (CBR) is the fraction of time during which the channel is considered busy. For example, the channel has a CBR of 50% if messages 500 ms of each second are used to transmit safety messages. To determine network congestion and to apply mitigation techniques, the inter-vehicle communication module periodoically determines the CBR of the DSRC channels.

When the safety channel is congested or near congested (e.g., a CBR greater than 85%, etc.), the inter-vehicle communication module uses one or more mitigation techniques to mitigate congestion on the safety channel. For example, the inter-vehicle communication module may (a) reduce the transmission power of the safety messages to reduce the number of vehicles within the communication range, (b) change message priority, (c) change message size, and/or (d) reduce the number of safety messages per second (sometime referred to as the Message Exchange Rate (MER)). However, because the safety concerns are different, communication requirements of vehicles moving slowly or stranded in a traffic jam are significantly different from vehicles under free-flow high-speed conditions. For example, speeds, density, acceleration and inter-vehicle gap between vehicles in traffic in one side of a divided highway may be different compared to vehicles moving in the opposite direction on the divided highway that are freely flowing. As a result, adopting the same congestion mitigation techniques for the vehicles with different needs may cause as many problems as it solves. For example, vehicles moving at high-speed under free-flow conditions require their communication settings to be stringent to accommodate low latency and low packet drop to facilitate lane change maneuver, and/or emergency braking etc. However, vehicles moving slowly in traffic may not need information about other slowly moving vehicles in such a timely manner.

As described below, the vehicles are sorted into communication groups based on similarity of vehicle characteristics (e.g., speed, direction of travel, lane of travel, road of travel, proximity, etc.). For example, vehicles in traffic on one side of the highway may be grouped together, vehicles on the free flowing side of the highway may be grouped together, and vehicles on an overpass above the highway may be grouped together. In some examples, a non-vehicle controller, via roadside units, collects the vehicle characteristics from the safety messages and assigns vehicle to communication groups. Alternatively, in some examples, the vehicles self-organize. In such examples, the vehicles join a communication group based on the vehicle characteristics of other proximate vehicles.

In some examples, the mitigation techniques are adopted by the vehicles in a communication group. In some such examples, the technique that is adopted is based on the vehicle characteristics. For example, if the vehicles in the communication group are moving slowly (e.g., less than 10 miles per hour, etc.), the vehicles may reduce their MER (or the non-vehicle controller may direct the vehicles to reduce their MER). The the vehicles determine whether the current channel (e.g., the safety channel) is congested (e.g., based on the CBR, etc.). In response to determining that the current channel is congested, the vehicle broadcasts a Channel Switch Request (CSR) message. In some examples, the non-vehicle controller tracks a number of CSR message over a period of time from vehicles in a communication group. In such examples, then a threshold number of CSR messages are received, the non-vehicle controller instructs the vehicles in the communication group to engage is congestion mitigation techniques. Additionally or alternatively, in some examples, the non-vehicle controller instructs the vehicles in the communication group to switch to a designated channel (e.g., from Channel 172 to Channel 174). In some such examples, the non-vehicle controller sends a message on the designated channel to instruct other vehicles not in the communication group to not communicate via the designated channel until further instructed by the non-vehicle controller. Alternatively, in some examples, when a vehicle receives a CSR message from another vehicle in the communication group, the vehicle switches to a designated channel and/or initiates a congestion mitigation technique based on average characteristics of the vehicles in the communication group. In some examples, when the current channel is congested, the vehicles and/or roadside units communicate via a different wireless module, such as a cellular module.

Vehicles in traffic, on a macro level, often act in a similar manner. In some examples, when the roadside unit(s) coordinate the congestion mitigation, the vehicles reduce their MER. The roadside unit(s) collect the safety messages from the vehicles and generate an aggregate safety message for the communication group to be broadcast. In some such examples, the aggregate safety message includes (a) high level road geometry in the congested area, (b) number, density, direction and average speed of vehicles in the corresponding communication group, (c) any special safety information (e.g., location of an accident, etc.) within the area corresponding to the communication group, (d) instructions for channel selections, and/or (e) cardinal direction mapping with respect to a specific vehicle (e.g., a vehicle that requires special attention, such as a vehicle involved in an accident, etc.), etc. As used herein, vehicle density refers to an average spacing between vehicles.

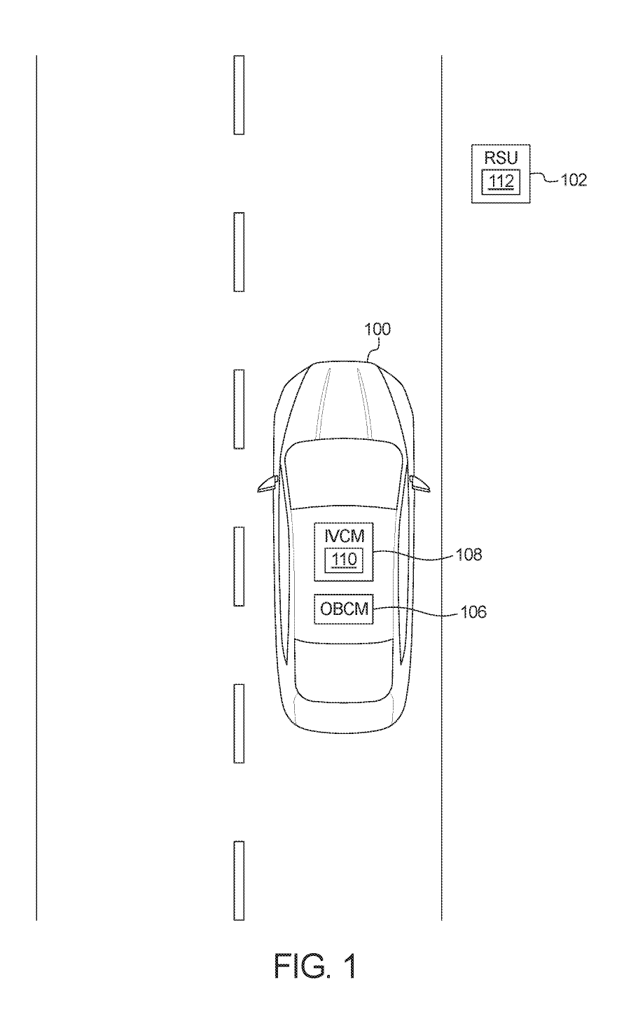

FIG. 1 illustrates a vehicle 100 and a roadside unit (RSU) 102 operating in accordance with the teachings of this disclosure. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). In the illustrated example the vehicle 100 includes an on-board communication module 106 and an inter-vehicle communication module 108.

The on-board communication module 106 includes wireless network interfaces to enable communication with external networks. The on-board communication module 106 also includes hardware (e.g., processors, memory, storage, antenna, etc.) and software to control the wireless network interfaces. In the illustrated example, the on-board communication module 106 includes one or more communication controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); local area wireless network (including IEEE 802.11 a/b/g/n/ac or others), etc.). The external network(s) may be a public network, such as the Internet; a private network, such as an intranet; or combinations thereof, and may utilize a variety of networking protocols now available or later developed including, but not limited to, TCP/IP-based networking protocols.

The inter-vehicle communication module 108 includes antenna(s), radio(s) and software to broadcast messages and to establish communication between the vehicle 100, other vehicles, and the roadside units 102. The inter-vehicle communication module 108 communicates via a range of frequencies (e.g., 5.850 to 5.925 GHz) that is divided into multiple channels. More information on the inter-vehicle communication network and how the network may communicate with vehicle hardware and software is available in the U.S. Department of Transportation's Core June 2011 System Requirements Specification (SyRS) report (available at http://www.its.dot.gov/meetings/pdf/CoreSystem_SE_SyRS_RevA%20(2011-06-13).pdf), which is hereby incorporated by reference in its entirety along with all of the documents referenced on pages 11 to 14 of the SyRS report. The inter-vehicle communication systems may be installed on vehicles and along roadsides on infrastructure. The inter-vehicle communication systems incorporated into infrastructure (e.g., traffic signals, street lights, municipal cameras, etc.) is known as a “roadside” system or unit. inter-vehicle communication may be combined with other technologies, such as Global Position System (GPS), Visual Light Communications (VLC), Cellular Communications, and short range radar, facilitating the vehicles communicating their position, speed, heading, relative position to other objects and to exchange information with other vehicles or external computer systems. inter-vehicle communication systems can be integrated with other systems such as mobile phones.

In some examples, the inter-vehicle communication module 108 implements the Dedicated Short Range Communication (DSRC) protocol. Currently, the DSRC network is identified under the DSRC abbreviation or name. However, other names are sometimes used, usually related to a Connected Vehicle program or the like. Most of these systems are either pure DSRC or a variation of the IEEE 802.11 wireless standard. However, besides the pure DSRC system it is also meant to cover dedicated wireless communication systems between cars and roadside infrastructure system, which are integrated with GPS and are based on an IEEE 802.11 protocol for wireless local area networks (such as, 802.11p, etc.).

In the illustrated example, the inter-vehicle communication module 108 includes a congestion manager 110. The congestion manager 110 detects when the current channel being used to communicate safety messages is congested and takes action to mitigate the congestion. The actions to mitigate congestion are performed in conjunction with other vehicles in an organized communication group (e.g., organized via roadside units 102, etc.) or an self-organized ad hoc communication group. In some examples, to communicate these actions, the congestion manager 110 communicates with the roadside unit 102 via a central server using a different communication protocol, such as cellular communication through the on-board communication module 106.

To organize into an ad hoc communication group, the congestion manager 110 analyzes vehicle characteristics information from the safety message received from other vehicles in comparison to its own vehicle characteristics. These vehicle characteristics include direction of travel, lane of travel, speed, type or road network (e.g., highway, city street, frontage road, etc.) currently traversing, and/or type of vehicle (e.g., public safety, personal, public transport, etc.), etc. In some examples, the congestion manager 110 identifies proximate other vehicles that have similar characteristics and follows congestion mitigation techniques as communicated by those similar other vehicles. Additionally, when communication congestion is detected, the congestion manager 110 broadcasts mitigation technique(s) to inform other vehicles with similar characteristics.

The congestion manager 110 detects when the current channel for safety messages is congested. In some examples, the congestion manager 110 measures a channel busy ratio (CBR) that measures the fraction of time during which the time slices are used. For example, the congestion manager 110 may determine the channel is congested when the CBR is 85%. In some examples, the congestion manager 110 determines that the channel is congested when it cannot send a safety message over the channel a threshold number of times. For example, the congestion manager 110 may determine that the channel is congested when it cannot broadcast (e.g., because another vehicle is broadcasting) a safety message for 5 out of the latest 10 attempts. In some examples, the congestion manager 110 determines that the channel is congested when safety message are received from a threshold number of distinct vehicles. For example, the congestion manager 110 may determine that the channel is congested when safety message have been received by 240 distinct vehicles in the past second. When the congestion manager 110 determines that the current channel for safety message is congested, the congestion manager 110 sends a channel switch request message (e.g., via the inter-vehicle communication module 108, via the on-board communication module 106, etc.). In some examples, the channel switch request message includes an alternate channel for the communication group and/or a congestion mitigation technique.

When the congestion manager 110 receives a channel switch request message from another vehicle in the communication group or a channel switch direction message from a roadside unit 102, the congestion manager 110 performs the instructions in message (e.g., switches channels, etc.) and/or performs predetermined mitigations technique(s) based on aggregate vehicle characteristics of the communication group. In some examples, when the congestion manager 110 receives channel switch request message that includes instructions to switch channels from another vehicle not in the same communication group, the congestion manager 110 prevents other applications from transmitting on that channel.

In some examples, congestion manager 110 implements congestion mitigation techniques based on the aggregate vehicle characteristics of the vehicles in the communication group. In some examples, the congestion manager 110 reduce the transmission power of the safety messages and/or reduces the number of safety messages per second. In some examples, when the vehicles in the communication group are moving slowly (e.g., under 32 kilometers per hour (kph) (20 miles per hour (mph)), the congestion manager 110 reduces the number of safety messages per second based on the average speed of the vehicles in the communication group. Generally, the slower the vehicles in the communication group travel, the lower the frequency of safety messages because the timeframe for decision making (e.g., to avoid collisions, etc.) and thus the need to frequent up-to-date information is not as necessary as vehicles traveling at similar speeds are traveling slower. For example, when the average speed of the communication group is between 16 and 32 kph (10 to 20 mph), the congestion manager 110 may reduce the number of safety messages per second to seven message per second (e.g., instead of ten messages per second, etc.). As another example, when the average speed of the communication group is less than 16 kph (10 mph), the congestion manager 110 may reduce the number of safety messages per second to five message per second. In some examples, the congestion manager 110 modifies the transmission power of the safety messages based on a density of the vehicles in the communication group and/or the average distance between vehicles in the communication group. Generally, as traffic in a communication group with similar vehicle characteristics become more dense, the range to the safety message can be lessened and information about relatively proximate vehicles can be generalized to the vehicle group. For example, when the average distance between vehicles in the communication group is a car length or less (e.g., between 4.30 meters (m) (14.0 feet) and 4.45 m (14.3 feet)), the congestion manager 110 may reduce the transmission power of the safety messages so that the safety messages have a range of 500 meters instead of 1000 meters.

The roadside units 102 are inter-vehicle communication platforms that are positioned next to a roadway to communicate with vehicles traversing the roadway. In the illustrated example, the roadside unit 102 includes a group manager 112. The group manager 112 (a) coordinates the vehicles 100 into communication groups, (b) coordinates congestion mitigation techniques for the communication groups, and/or (c) compiles and broadcasts aggregate safety messages for the vehicle communication group(s) in its range. The group manager 112 analyzes the vehicle characteristic information in the safety messages to organize the vehicle communication groups based on the vehicle characteristics. When the group manager 112 broadcasts instructions to mitigate communication congestion, the group manager 112 includes information so that the vehicles can identify if they are in the affected communication group. The group manager 112 determines the communication congestion based on the CBR of the safety channel and/or the number of distinct vehicles from which it receives safety message. Alternatively or additionally, in some examples, the group manager 112 determines that the safety channel is congested when it receives a threshold number of channel switch request messages from different vehicles associated with a communication group in a defined period of time. For example, the group manager 112 may determine that the safety channel is congested when it receives channel switch request messages from ten vehicles in a span of a second. In some examples, the channel switch request message are received via inter-vehicle communication. Alternatively or additionally, in some examples, the channel switch request message are received via another communication protocol, such as a cellular protocol. In such examples, the group manager 112 receives the channel switch request messages sent using the alternatively protocol via the central server. When the safety channel is congested, the group manager 112 sends a channel switch message to vehicles in one or more of the communication groups to instruct them to switch channels. Additionally or alternatively, the channel switch message include other congestion mitigation instructions, such as reducing the number of safety messages per second and/or reducing transmission power. In some such examples, as described above, the group manager 112 bases the mitigation techniques on the average vehicle characteristics of the vehicles in the communication group.

In some examples, the group manager 112 instructs vehicles in the communication group to reduce the time per second that they transmit the safety messages. In such examples, the group manager 112 aggregates the safety messages and periodically broadcasts an aggregated safety message. The aggregate safety message includes the average vehicle characteristics of the vehicles in the communication group, high level road geometry of the area encompassed by the communication group, a number of vehicles within the communication group, any special safety information (e.g., location of an accident, etc.), location information (e.g., coordinates, etc.) of specially flagged vehicles within the communication group (e.g., vehicles that need assistance, etc.). For example, the aggregate safety message may specify that The vehicles within the communication group use the aggregate safety messages to supplement the regular safety message received from nearby vehicles. Additionally, vehicles not in the communication group, such as vehicles approaching the vehicles in the communication group, use the aggregate message to perform vehicular functions based on aggregate safety messages.

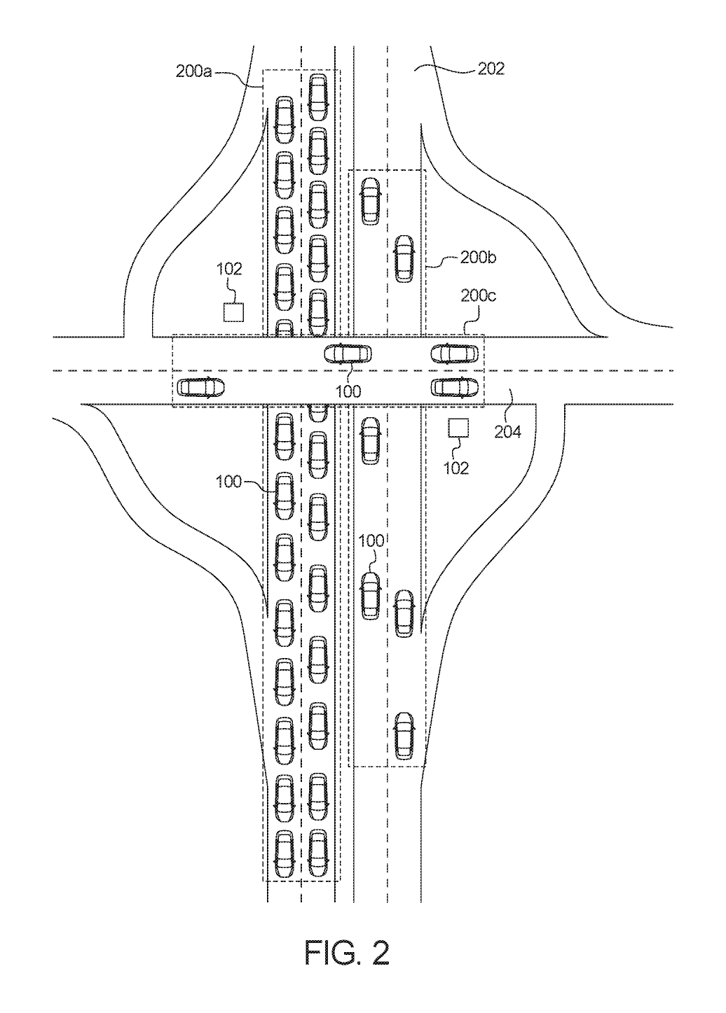

FIG. 2 illustrates the vehicles 100 of FIG. 1 formed into communication groups 200a, 200b, and 200c. In the illustrated example, the communication groups 200a, 200b, and 200c are formed based on similar vehicle characteristics. As a result, the transmission characteristics (e.g., messages per second, transmission power, etc.) of the vehicles in the different communication groups 200a, 200b, and 200c can be different. A second communication group 200b includes vehicles 100 traveling on the other side of the divided highway 202 traveling in the opposite direction. A third communication group 200c includes vehicles 100 traveling on an overpass 204 that spans the divided highway 202. In the illustrated example, a first communication group 200a includes vehicles 100 in close proximity traveling slowly on one side of a divided highway 202. The example first communication group 200a is experiencing traffic congestion that causes a large number of vehicles (e.g., 111-155 vehicles per lane-kilometer, etc.) to congregate within the communication range of the inter-vehicle communication module 108. As a result, the first communication group cause communication congestion that also affects the vehicles 100 in the second communication group 200b and the vehicles 100 in the third communication group 200c. In such an example, the vehicles 100 in the second communication group 200b and the third communication group and/or the roadside units 102 direct the vehicles 100 in the corresponding communication groups 200b and 200c to switch channels and/or the vehicles 100 in the first communication group 200a to perform communication congestion mitigation techniques, such as reducing the frequency of broadcasting safety messages.

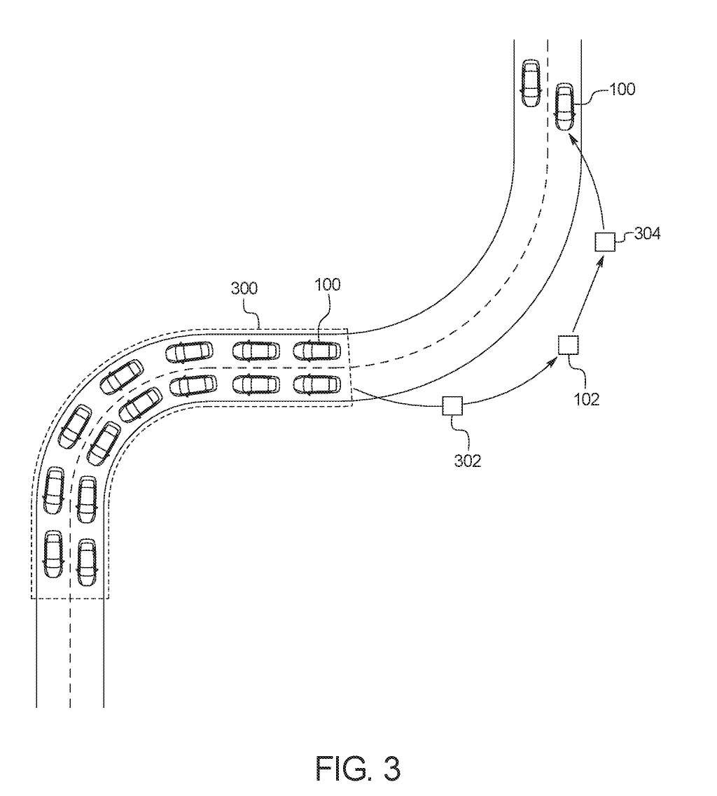

FIG. 3 illustrates the roadside unit 102 coordinating communication groups 300. In the illustrated example, the roadside unit 102 instructs the vehicles 100 in the communication group 300 to lower the number of safety messages 302 broadcast per second. The roadside unit 102 then aggregates the safety messages 302 to from an aggregate safety message 304. The roadside unit then periodically broadcasts the aggregate safety message 304. Vehicles 100 not in the communication group 300 may receive the aggregate safety message 304 and use the information to make decisions regarding its relationship to the vehicles 100 within the communication group 300. Additionally, the vehicles 100 within the communication group 300 use the information in the aggregate safety message 304 to supplement information received from the individual safety messages.

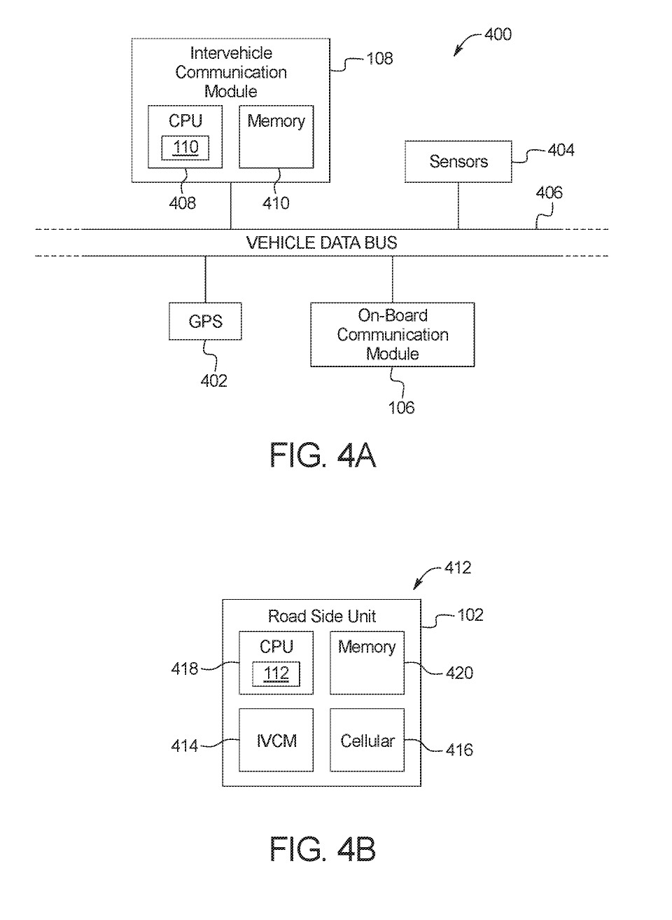

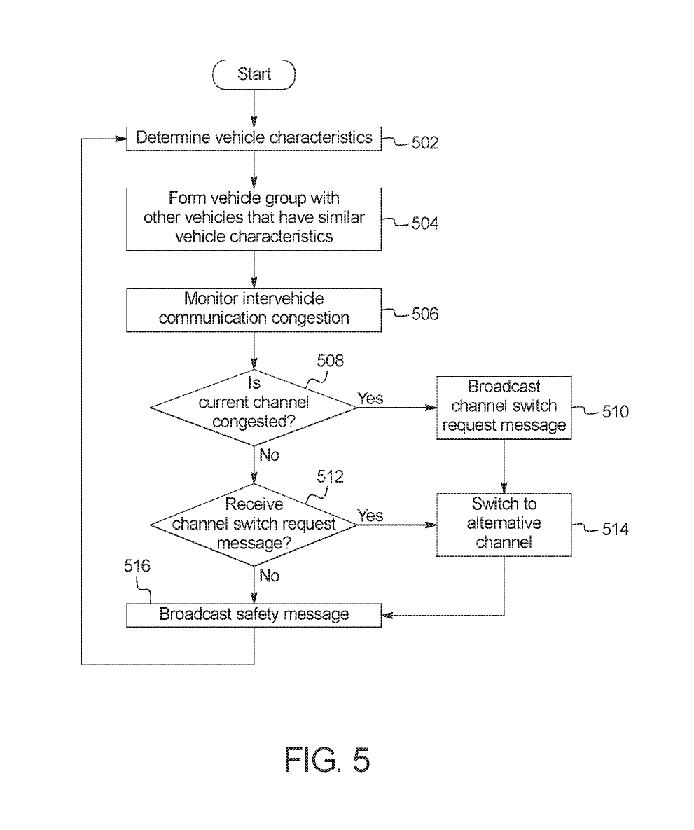

FIG. 4A is a block diagram of electronic components 400 of the vehicles 100 of FIGS. 1, 2, and 3. In the illustrated example, the electronic components of the vehicle 100 include the on-board communication module 106, the inter-vehicle communication module 108, a global positioning system (GPS) receiver 402, sensors 404, and a vehicle data bus 406.

In the illustrated examples, the inter-vehicle communication module 108 includes a processor or controller 408 and memory 410. In the illustrated example, the inter-vehicle communication module 108 is structured to include congestion manager 110. The GPS receiver 402 provides coordinates of the vehicle 100. In some examples, the GPS receiver 402 is incorporated into the on-board communication module 106 or the inter-vehicle communication module 108. The sensors 404 may be arranged in and around the vehicle 100 in any suitable fashion. The sensors 404 may mounted to measure properties around the exterior of the vehicle 100. Additionally, some sensors 404 may be mounted inside the cabin of the vehicle 100 or in the body of the vehicle 100 (such as, the engine compartment, the wheel wells, etc.) to measure properties in the interior of the vehicle 100. For example, such sensors 404 may include accelerometers, odometers, tachometers, pitch and yaw sensors, wheel speed sensors, microphones, tire pressure sensors, and biometric sensors, etc. The measurements from the sensors 404 are used, in part, to generate the vehicle characteristics information.

The vehicle data bus 406 communicatively couples the on-board communication module 106, the inter-vehicle communication module 108, the GPS receiver 402, and/or the sensors 404. In some examples, the vehicle data bus 406 includes one or more data buses. The vehicle data bus 406 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

FIG. 4B is a block diagram of the electronic components 412 of the roadside units 102 of FIGS. 1, 2, and 3. In the illustrated example, the roadside units 102 includes an inter-vehicle communication module 414, a cellular communication module 416, a processor or controller 418, and memory 420. In the illustrated example, the roadside unit 102 is structured to include group manager 112. The cellular communication module 416 includes hardware (e.g., processors, memory, storage, antenna, etc.) and software to control the cellular network interfaces. In the illustrated example, the cellular communication module 416 includes one or more communication controllers for cellular networks (e.g., Global System for Mobile Communications (GSM), Universal Mobile Telecommunications System (UMTS), Long Term Evolution (LTE), Code Division Multiple Access (CDMA), etc.).

The processors or controllers 408 and 418 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 410 and 420 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory 410 and 420 include multiple kinds of memory, particularly volatile memory and non-volatile memory.

The memory 410 and 420 are computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 410 and 420, the computer readable medium, and/or within the processors 408 and 418 during execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

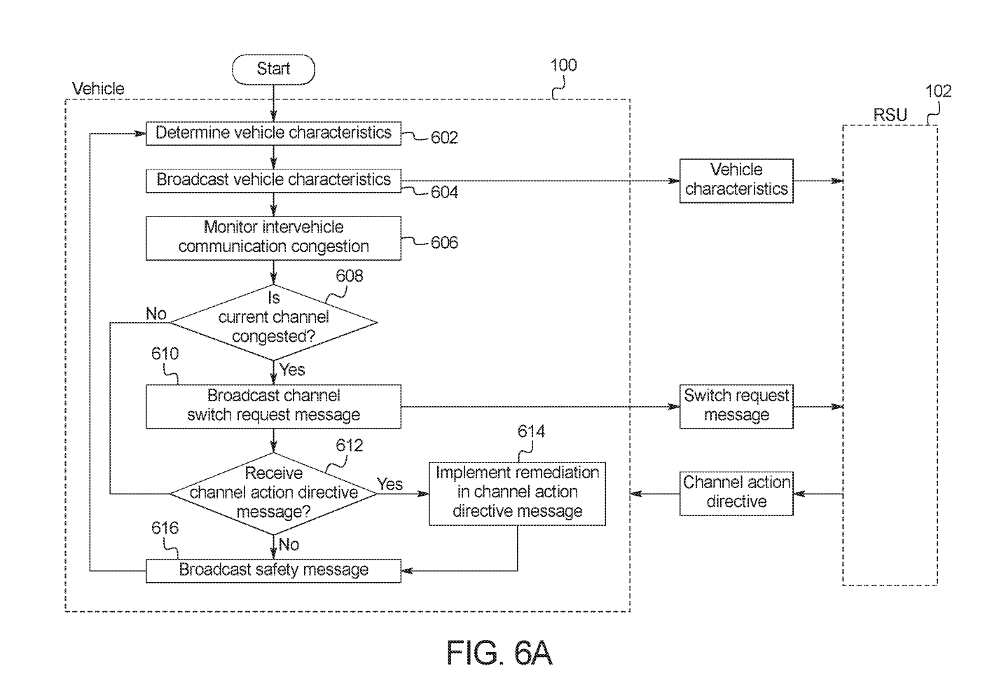

FIG. 5 is a flowchart of a method to coordinate communication groups (e.g., the communication groups 200a, 200b, 200c, and 300 of FIGS. 2 and 3 above) to mitigate network congestion, which may be implemented by the electronic components 400 of FIG. 4A. Initially, at block 502, the congestion manager 110 determines vehicle characteristics of the vehicle 100. The congestion manager 110 determines vehicle characteristics using the sensors 404, the GPS receiver 402, and/or navigation data, traffic data, and/or horizon data (e.g., road topology information, speed limits, surface material, etc.) from a navigation system, etc. The vehicle characteristics include direction of travel, density of proximate vehicles, speed of travel, type of road, lane position, type of vehicle, and/or time of day, etc. At block 504, the congestion manager 110 forms a communication group (e.g., the communication groups 200a, 200b, and 200c of FIG. 2 above) with other vehicles with similar vehicle characteristics received from safety messages. In some examples, the communication group is not a formal group. That is, in such examples, the congestion manager 110 identifies vehicles that have similar vehicle characteristics and acts on channel switch request messages sent by those vehicles. In such a manner, the vehicles form an ad hoc communication group with no centralized controlling vehicle.

At block 506, the congestion manager 110 monitors the network congestions of the inter-vehicle communication. At block 508, the congestion manager 110 determines whether there is network congestion. If there is network congestion, the method continues to block 510. If there is no network congestion, the method continues at block 512. At block 510, the congestion manager 110 broadcasts a channel switch request message. In some examples, the congestion manager 110 includes an alternate channel or a progression of alternate channels to use for the safety channel for the communication group.

At block 512, the congestion manager 110 determines whether it has received a channel switch message from another vehicle in the communication group. If a channel switch message from another vehicle in the communication group has been received, the method continues at block 514. Otherwise, if a channel switch message from another vehicle in the communication group has not been received, the method continues at block 516. At block 514, the congestion manager 110 switches to the alternative channel for the safety message. At block 516, the congestion manager 110 broadcasts a safety message. The method then returns to block 502.

The flowchart of FIG. 5 is representative of machine readable instructions stored in memory (such as the memory 410 of FIG. 4A) that comprise one or more programs that, when executed by a processor (such as the processor 408 of FIG. 4A), cause the vehicle 100 to implement the example congestion manager 110 of FIGS. 1 and 4A. Further, although the example program(s) is/are described with reference to the flowchart illustrated in FIG. 5, many other methods of implementing the example congestion manager 110 may alternatively be used. For example, the order of execution of the blocks may be changed, and/or some of the blocks described may be changed, eliminated, or combined.

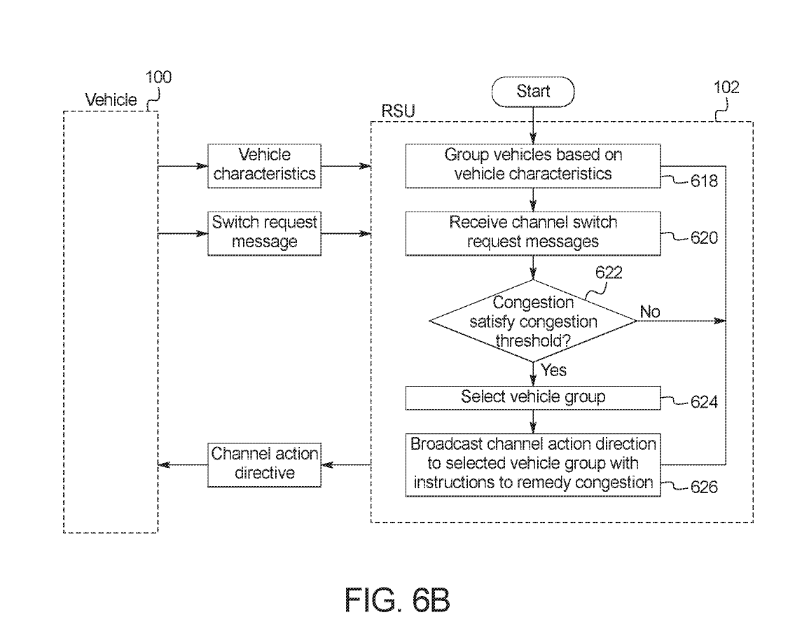

FIGS. 6A and 6B are a flowchart of a method to coordinate communication groups to mitigate network congestion, which may be implemented by the electronic components 400 and 412 of FIGS. 4A and 4B. Initially, at block 602 (FIG. 6A), the congestion manager 110 of the vehicle 100 determines vehicle characteristics of the vehicle 100. At block 604, the the congestion manager 110 broadcasts the vehicle characteristic information. At block 606, the congestion manager 110 monitors the network congestions of the inter-vehicle communication. At block 608, the congestion manager 110 determines whether there is network congestion. If there is network congestion, the method continues to block 610. If there is no network congestion, the method continues at block 612. At block 610, the congestion manager 110 broadcasts a channel switch request message. At block 612, the congestion manager 110 determines whether a channel action directive message has been received from a roadside unit 102. If a channel action directive message has been received, the method continues at block 614. Otherwise, if the channel action directive message has not been received, the method continues at block 616. At block 614, the congestion manager 110 preforms the mitigation technique in the channel action directive message. At block 616, the congestion manager 110 broadcasts a safety message.

At block 618 (FIG. 6B), the group manager 112 of the roadside unit 102 groups vehicles 100 into communication groups based on the vehicle characteristic information received from the vehicles 100. At block 620, the group manager receives the channel switch request message(s) from the vehicle 100. At block 622, the group manager 112 determines whether the network congests, as indicated by the channel switch request message(s) satisfies a congestion threshold. For example, the congestion threshold may be a number of channel switch request message(s) from different vehicles 100 in an amount of time (e.g., one second, etc.). At block 624, when the congestion threshold is satisfied, the group manager 112 selections one of the vehicle communication groups. In some examples, the group manager 112 selects one of the vehicle communication groups based on the aggregate vehicle characteristics of the vehicles in the communication group. For example, the group manager 112 may select the communication group associated with the most vehicles and/or the communication group with the fastest average speed. At block 626, the group manager 112 broadcasts a channel active directive to the vehicles in the selected communication group with instructions to mitigate the congestions. For example, the channel active directive may include an alternative channel, instructions regarding a number of safety messages per second, instructions regarding transmission power, etc.

The flowchart of FIGS. 6A and 6B is representative of machine readable instructions stored in memory (such as the memory 410 and 420 of FIGS. 4A and 4B) that comprise programs that, when executed by respective processors (such as the processors 408 and 418 of FIGS. 4A and 4B), cause the vehicle 100 to implement the example congestion manager 110 of FIGS. 1 and 4A and the roadside unit 102 to implement the example group manager 112 of FIGS. 1 and 4B. Further, although the example programs are described with reference to the flowchart illustrated in FIGS. 6A and 6B, many other methods of implementing the example congestion manager 110 and the example group manager 112 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. As used here, the terms “module” and “unit” refer to hardware with circuitry to provide communication, control and/or monitoring capabilities, often in conjunction with sensors. “Modules” and “units” may also include firmware that executes on the circuitry. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a wireless communication module; and
an intervehicle communication module to:
form a communication group with other vehicles based on vehicle characteristics;
monitor network congestion of a first channel;
in response to detecting network congestion on the first channel:
broadcast a switch message to instruct the other vehicles to switch to a second channel; and
broadcast safety messages on the second channel.

2. The vehicle of claim 1, wherein the intervehicle communication module is to, in response to receiving the switch message from one of the other vehicles in the communication group, broadcast the safety messages on the second channel.

3. The vehicle of claim 1, wherein the vehicle characteristics include a direction of travel of the vehicle.

4. The vehicle of claim 1, wherein the vehicle characteristics include a range of speeds.

5. The vehicle of claim 1, where in the vehicle characteristics include a type of road on which the vehicle is traversing.

6. The vehicle of claim 1, wherein the vehicle characteristics include a density of the other vehicles in an area around the vehicle.

7. The vehicle of claim 1, wherein the switch message is also to instruct the other vehicles to at least one of change a number of the safety messages broadcast per second or reduce a transmission power of the safety messages.

8. A method to control a vehicle comprising:
forming, with a processor, a communication group with other vehicles within communication range of an intervehicle communication module based on vehicle characteristics;
monitoring network congestion of a first channel;
in response to detecting network congestion on the first channel:
broadcasting a switch message to instruct the other vehicles to switch to a second channel; and
broadcasting safety messages on the second channel.

9. The method of claim 8, including in response to receiving the switch message from one of the other vehicles in the communication group, broadcasting the safety messages on the second channel.

10. The method of claim 8, wherein the vehicle characteristics include a direction of travel of the vehicle, a range of speeds, a type of road on which the vehicle is traversing, and a density of the other vehicles in a vicinity of the vehicle.

11. The method of claim 8, wherein the switch message is also to instruct the other vehicles to at least one of change a number of the safety messages broadcast per second or reduce a transmission power of the safety messages.

12. A system comprising:
a plurality of vehicles to:
broadcast safety messages on a first channel;
monitor network congestion of the first channel;
in response to detecting network congestion on the first channel, broadcast a switch request message;
a roadside unit:
assign a first set of the plurality of vehicles into a first communication group based on a first set of common vehicle characteristics;
assign a second set of the plurality of vehicles into a second communication group based on a second set of common vehicle characteristics; and
in response to receiving a threshold number of the switch request messages from different ones of the plurality of vehicles over a threshold period of time, broadcast a directive message to the first set of the plurality of vehicles in the first communication group, the directive message causing the first set of the plurality of vehicles to change parameters of broadcasting the safety messages.

13. The system of claim 12, wherein the plurality of vehicles detect network congestion when a channel busy ratio is greater than a threshold level.

14. The system of claim 12, wherein the plurality of vehicles detect network congestion when a number of the plurality of vehicles is greater than a threshold.

15. The system of claim 12, wherein the first and second sets of common vehicle characteristics include a direction of travel, a range of speeds, a type of road, and a density of the plurality of vehicles.

16. The system of claim 12, wherein the directive message causes the first set of the plurality of vehicles to broadcast the safety messages on a second channel while the second set of the plurality of vehicles continue to broadcast the safety messages on the first channel.

17. The system of claim 12, wherein the directive message causes the first set of the plurality of vehicles to broadcast the safety messages using a first transmission power while the second set of the plurality of vehicles continue to broadcast the safety messages using a second transmission power.

18. The system of claim 12, wherein the directive message causes the first set of the plurality of vehicles to broadcast the safety messages a first number of times a second while the second set of the plurality of vehicles continue to broadcast the safety messages at a second number of times per second.

19. The system of claim 18, wherein the roadside unit is to broadcast aggregate safety messages based on the safety messages received by the first set of the plurality of vehicles.

20. The system of claim 19, wherein the aggregate safety messages include (a) a number, density, direction of travel, lane distribution, and average speed of the first set of the plurality of vehicles, and (b) road geometry of an area encompassing the first set of the plurality of vehicles.
